(19) United States
(12) Patent Application Publication
(10) Pub. No.: US 2025/0024940 A1
(43) Pub. Date: Jan. 23, 2025

(54) PARALLELLY-CONNECTABLE STORAGE RACK

(71) Applicant: Shenzhen Tongzhitai Technology Co., Ltd., Shenzhen (CN)

(72) Inventor: Huaqiao HUANG, Shenzhen (CN)

(21) Appl. No.: 18/628,929

(22) Filed: Apr. 8, 2024

(30) Foreign Application Priority Data
Jul. 18, 2023 (CN) 202321891025.6

(51) Int. Cl. A47B 57/40; A47B 47/00; A47B 87/00; A47B 96/20

(52) U.S. Cl. CPC A47B 57/40; A47B 47/0083; A47B 96/201; A47B 87/005

(57) ABSTRACT

The present disclosure discloses a parallelly-connectable storage including: a plurality of bamboo-joint rods provided with a plurality of installation positions in their length direction; a clip piece arranged at the installation position of the bamboo-joint rod; a main tier-panel, of which four corners are respectively provided with a tapered casing trapping the clip piece, and which is respectively provided with two hook holes on two end faces spliced with each other; and an accessory tier-panel, of which two corners of one end is provided with tapered casings used to trap the clip piece, wherein two hook holes are opened on the end face of one side provided with the tapered casings, and of which the other end is provided with two hooks used to fit with two hooks used to connect with the hook holes disposed on the main tier-panel or other accessory tier-panels at the same height.

### CROSS-REFERENCE TO RELATED PATENT APPLICATION

This application claims priority from the Chinese patent application 202321891025.6, filed Jul. 18, 2023, the content of which is incorporated herein in the entirety by reference.

### TECHNICAL FIELD

The present disclosure relates to the technical field of home furnishing, in particular to a parallelly-connectable storage rack.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

People are now willing to buy a variety of items with the improvement of living standards, but increased shopping occurs concurrently with the problem of item storage, so most people choose to use storage racks to store various items. Most of the storage racks sold on the market have a kind of fixed structure provided by manufacturers and it is impossible for the storage racks to add storage panels on demands to increase the storage capacity. Accordingly, another kind of storage racks where storage panels can be additionally stacked in the height direction come on the market, but if too high height causes poor stability, it is risked with toppling over; in addition, in view of the diversity of items, storing this kind of items also presents certain requirements for the length of the storage racks.

### SUMMARY

In order to solve the technical problem that the storage racks existing in the prior art can only be superimposed in the height direction with poor stability, the present disclosure provides a parallelly-connectable storage rack.

A parallelly-connectable storage provided in the present disclosure as a technical solution includes:
a plurality of bamboo-joint rods, which are vertically arranged, and each of which is provided with a plurality of installation positions in its length direction;
a clip piece arranged at the installation position of the bamboo-joint rod;
a main tier-panel, of which four corners are respectively provided with a tapered casing trapping the clip piece, and which is respectively provided with two hook holes on two end faces spliced with each other; and
an accessory tier-panel, of which two corners of one end is provided with tapered casings used to trap the clip piece, wherein two hook holes are opened on the end face of one side provided with the tapered casings, and of which the other end is provided with two hooks used to connect with the hook holes disposed on the main tier-panel or other accessory tier-panels at the same height.

Preferably, the main tier-panel and the accessory tier-panel both include a edge frame and a storage plate, and the storage plate is fixed on the inner edge of the edge frame.

Preferably, the hook hole is formed by way of pressing the edge frame outwards as a through groove protruding outwards at middle and opening upwards and downwards, the hook on the accessory tier-panel faces downwards and is hung in the hook hole during assembling.

Preferably, the storage plate may be a metal sieve pore plate or a wooden board.

Further, the clip piece includes a first clipping piece and a second clipping piece, and the first clipping piece and the second clipping piece are each a semicircular rod wall; a concave portion and a convex portion are respectively disposed on the two mounting sides of the first clipping piece, correspondingly a concave portion and a convex portion matched with the first clipping piece are respectively disposed on the two mounting sides of the second clipping piece, thus the first clipping piece and the second clipping are spliced with each other to be like a tube.

Further, an annular groove is set at the installation position of the bamboo-joint rod, and a protruding restricting ring is set on the inner side of the clip piece, thus the restricting ring is trapped in the annular groove at the installation position of the bamboo-joint rod.

Compared with the prior art, by way of arranging hooks and hook holes at two ends of the main tier-panel and the accessory tier-panel, the present disclosure enables the two ends of the main tier-panel to be connected with the accessory tier-panel at the same height, and the accessory tier-panel to be successively connected with other accessory tier-panels at the same height, so that the accessory tier-panels can be connected infinitely with each other in the horizontal direction, thereby solving the problem that in the prior art the storage plates can only be superimposed along the height of the storage rack with poor stability; moreover, by way of arranging the clip pieces at the installation positions of different heights of the bamboo-joint rod, it also enables the spacing between tier-panels to change for the main tier-panel and the accessory tier-panel, and by way of further arranging more clip pieces and installing more tier-panels, it further enables the storage rack not only to be connected in parallel, but also to change the spacing and number of tier-panels in the vertical direction, so as to make use more flexible.

### BRIEF DESCRIPTION OF THE DRAWINGS

In order to more clearly illustrate the technical solutions in the examples of the present disclosure, we shall briefly describe the drawings that need to be used in the description to the examples or the prior art as follows. Obviously, the drawings described as follows only represent some examples of the present disclosure, so a person skilled in the art can conceive other drawings on the basis of these drawings without making creative work.

FIG. 1 is a right view of the example of the present disclosure.

FIG. 2 is a right exploded view of the example of the present disclosure.

FIG. 2a is an enlarged view of the hook hole in FIG. 2.

FIG. 3 is a left view of the example of the present disclosure.

FIG. 4 is a left exploded view of the example of the present disclosure.

FIG. 5 is a diagram of the clip piece of the present disclosure.

FIG. 6 is a diagram of the sieve pore plate of the present disclosure.

Where, 1—main tier-panel; 2—accessory tier-panel; 3—tapered casing; 4—bamboo-joint rod; 5—hook hole; 6—hook; 7—clip piece; 8—sieve pore plate.

### DETAILED DESCRIPTION OF SOME EMBODIMENTS

In order to make the technical problem to be solved by the present disclosure, the technical solution and the beneficial effect more clearly understood, we shall further explain the present disclosure in detail below in combination with the drawings and embodiments. It should be understood that the embodiments described herein are only used to explain the present disclosure, but not intended to pose any limitations on the present disclosure.

Now, we shall describe the principle and structure of the present disclosure in detail in combination with the drawings and embodiments as follows.

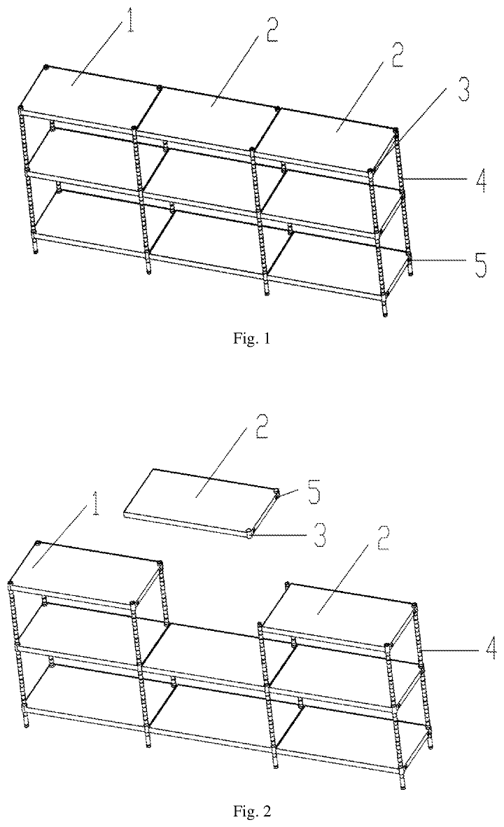

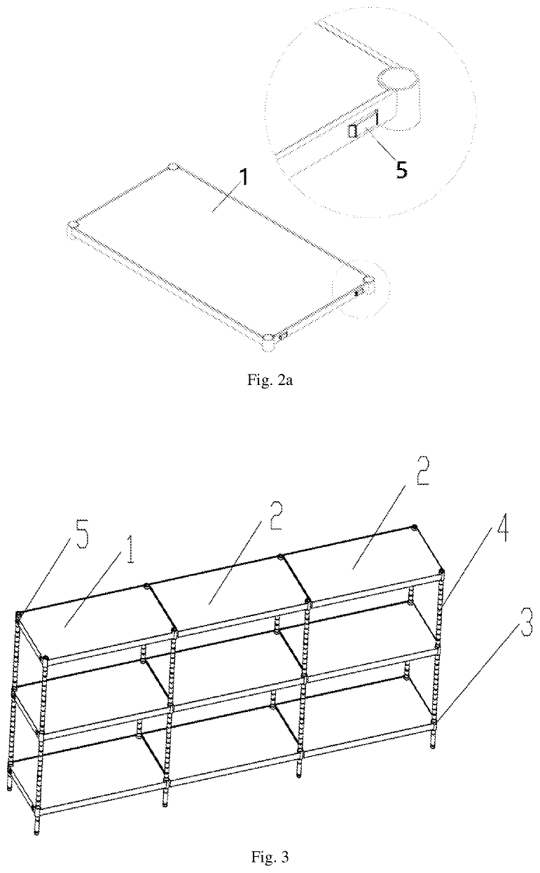

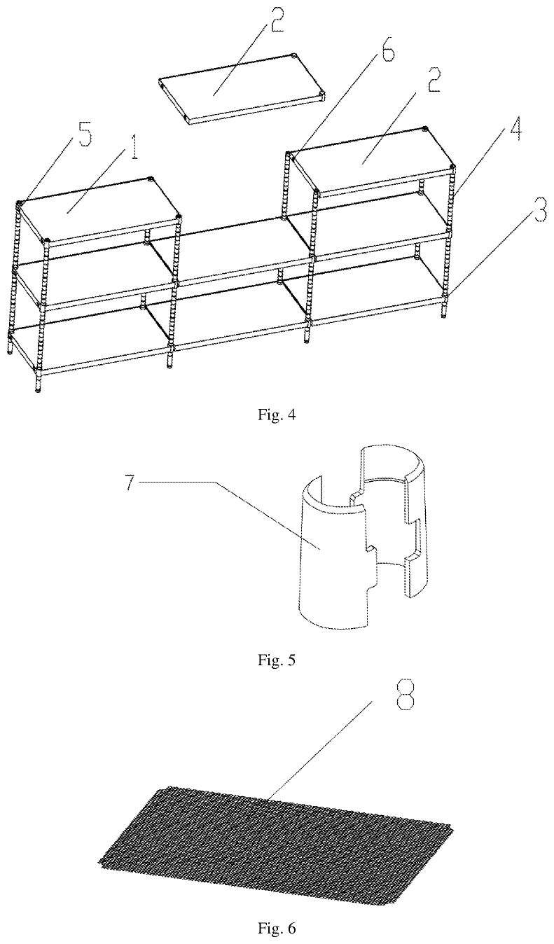

As shown in FIGS. 1-5, the parallelly-connectable storage provided in the present disclosure includes bamboo-joint rods 4, clip pieces 7, a main tier-panel 1 and an accessory tier-panel 2. A plurality of bamboo-joint rods 4 are vertically arranged, and each provided with a plurality of installation positions in its length direction; a plurality of clip pieces 7 are arranged at the installation positions of the bamboo-joint rods 4. The main tier-panel has four corners that are respectively provided with the tapered casing 3, thus fixed on the outside of the clip pieces that are installed and trapped by the tapered casings at the four corners on the bamboo-joint rods 4. Two hook holes 5 are set on the surface that splices the left and right sides of the main tier-panel 1, respectively. Of the accessory tier-panel 2, at the corners of its one side, two tapered casings 3 are set, correspondingly on the end face at its one end provided with the tapered casing, two hook holes 5 are opened, and on the end face of the other side, two hooks 6 are set. Of the accessory tier-panel 2, one side provided with the tapered casing is connected with the clip piece on the bamboo-joint rod 4, and one end face provided with the hook 6 can be connected with one end face, provided with hook hole 5, of the main tier-panel or the accessory tier-panel 2 at the same height.

The bamboo-joint rods 4 are vertically arranged as a plurality, and they are a cylindrical long rod on which a plurality of annular grooves are arranged at intervals, and around which the installation position is formed. The installation positions on bamboo-joint rod 4 are arranged at equal distances, and the installation positions are parallel to each other. The installation position on bamboo-joint rod 4 is used to mount the clip piece 7, which consists of two parts installed around the installation position of the bamboo-joint rod 4, and which is trapped in the tapered casing 3.

The main tier-panel 1 is rectangular, and the four corners of the main tier-panel 1 are respectively provided with the tapered casing 3 sleeving the outside of the clip piece 7 on the bamboo-joint rod 4 at the same height. Two hook holes 5 are respectively arranged on the two surfaces splicing the ends of the main tier-panel 1, and are used to fit with the hooks 6 arranged on the accessory tier-panel 2.

The accessory tier-panel 2 is the same size as the main tier-panel 1, and can be spliced with the main tier-panel 1 at the same height or spliced with other accessory tier-panels 2 at the same height. The tapered casings 3 are arranged at two corners of one side of the accessory tier-panel 2, and trap the clip pieces 7 of the bamboo-joint rod 4 at the same height. Two hook holes 5 are opened on the end face, provided with the tapered casings face, at one side of the accessory tier-panel 2, and their number and position are consistent with the hook holes 5 of the main tier-panel 1, correspondingly two hooks 6 are disposed on the other end face of the accessory tier-panel 2, and their number is consistent with the number of the hook holes 5 at one end of the main tier-panel 1. The hook 6 on the end face of the accessory tier-panel 2 is hooked with the hook hole 5 on the end face of the main tier-panel 1 at the same height, so that the main tier-panel 1 is spliced with the accessory tier-panel 2. One end of the accessory tier-panel 2 already connected to the main tier-panel 1 and provided with the hook hole 5 can be connected with one end of the other accessory tier-panels 2 provided with the hooks 6, so as to enable the main tier-panel 1 to be spliced with a plurality of accessory tier-panels 2.

In the example shown in FIGS. 1-5, four bamboo-joint rods 4 are vertically arranged and provided with the clip pieces 7 at the installation positions at the same height and with three tiers of the main tier-panels. The main tier-panels 1 are installed by way of making the tapered casings 3 of the four corners sleeve the outer side of the clip pieces 7 on the four bamboo-joint rods 4 at the same height. The three tiers of the main tier-panels 1 are parallel to each other, and are arranged at intervals at different heights of the bamboo-joint rod 4 to form a storage rack. The end faces of two sides of the main tier-panel 1 are respectively provided with two hook holes 5, which are positioned at the left side and the right side of each end face respectively, and the number and position of the hook holes 5 on one end face are the same with those on the other end face, thus conveniently spliced with the accessory tier-panel 2. The accessory tier-panel 2 is the same size as the main tier-panel 1, and of the accessory tier-panel 2, the two corners of the right side are provided with the tapered casings 3, and on the right side, two hook holes 5 are arranged, and the position and number of hook holes 5 are consistent with the position and number of hook holes 5 of the main tier-panel 1. Two hooks 6 are arranged on the left end face of the accessory tier-panel 2, and the position of the hook 6 is the same as the position of the hook hole 5 of the main tier-panel 1. The hook 6 on the left end face of the accessory tier-panel 2 can be hooked with any one of hook holes 5 on the right end face of the main tier-panel 1 at the same height, thus the accessory tier-panel 2 is spliced on the right side of the main tier-panel 1, and the accessory tier-panel 2 lies on the same horizontal plane together with the main tier-panel 1. The two tapered casings 3 on the right side of the accessory tier-panel 2 are connected with two bamboo-joint rods 4 and used to support the accessory tier-panel 2. In the same way, the accessory tier-panel 2 can be spliced on the left side of the main tier-panel 1. One end of the accessory tier-panel 2 already connected to the main tier-panel 1 and provided with the hook hole 5 is successively connected with one end of the accessory tier-panel 2 provided with the hook 6. Similarly, two ends of the main tier-panel 1 can be connected in parallel with a plurality of accessory tier-panels 2 at the same height, so that the storage rack can be assembled in the horizontal direction, so as to achieve the purpose of flexible use.

It should be noted that for the main tier-panels 1 or the accessory tier-panels 2 in the same vertical direction it is necessary to firstly install those at the bottommost tier, and then install other main tier-panels 1 or accessory tier-panels 2 upwards in proper order.

In one embodiment, the clip piece 7 is clipped on the installation position of the bamboo-joint rod 4, and the tapered casings 3 at the four corners of the main tier-panel 1 correspond to the clip pieces 7 at the same height, respectively. On four bamboo-joint rods 4, the clip pieces 7 can simultaneously arranged at different heights and a plurality of main tier-panels 1 are fixed and parallel to each other, in addition, the spacing between the main tier-panels 1 can be changed following the height of the clip piece 7 fixed on the bamboo-joint rod 4.

Preferably, the main tier-panel 1 and the accessory tier-panel 2 both include a edge frame and a storage plate. The edge frame is rectangular, the shape of the storage plate is the same as the shape of the inner edge of the edge frame, and the storage plate and the edge frame are spliced with each other to form the main tier-panel 1 or the accessory tier-panel 2. The storage plate may be a metal sieve pore plate or a wooden board. FIG. 6 shows an embodiment of using a metal sieve pore plate as the storage plate.

As shown in FIG. 2a, the hook hole 5 is formed by way of pressing a edge frame outwards as a through groove protruding outwards at middle and opening upwards and downwards, and the hole of the hook hole 5 is set vertically upwards, while the hook 6 on the accessory tier-panel faces downwards. During assembling, one end of the main tier-panel 1 or the accessory tier-panel 2 provided with the hook 6 is hung downwards in the hook holes 5 of the other main tier-panels 1 or accessory tier-panels 2.

As shown in FIG. 5, the clip piece 7 includes a first clipping piece and a second clipping piece, and the first clipping piece and the second clipping piece are each a semicircular rod wall; a concave portion and a convex portion are respectively disposed on the two mounting sides of the first clipping piece, correspondingly a concave portion and a convex portion matched with the first clipping piece are respectively disposed on the two mounting sides of the second clipping piece, thus the first clipping piece and the second clipping are spliced with each other to be like a tube.

Further, an annular groove is set at the installation position of the bamboo-joint rod 4, and a protruding restricting ring is set on the inner side of the clip piece 7, thus of the restricting ring, one part is located on the first clipping piece, and the other part is located on the second clipping piece. During installation, the restricting ring on the clip piece is stuck in the annular groove at the installation position of the bamboo-joint rod, so that the clip piece 7 is installed at the installation position of the bamboo-joint rod 4. The clip piece 7 is trapped in the tapered casing 3, which is thin at the top and thick at the bottom. When the tapered casing 3 traps the clip piece 7 downwards, it can firmly sleeve the clip piece 7. It should be noted that the specific connection mode of bamboo-joint rod 4, the clip piece 7 and the tapered casing 3 is relatively common in the prior art, but the other common fixed connections should also be included in the protection scope of the present disclosure.

Compared with the prior art, by way of arranging hooks and hook holes at two ends of the main tier-panel and the accessory tier-panel, the present disclosure enables the two ends of the main tier-panel to be connected with the accessory tier-panel at the same height, and the accessory tier-panel to be successively connected with other accessory tier-panels at the same height, so that the accessory tier-panels can be connected infinitely with each other in the horizontal direction, thereby solving the problem that in the prior art the storage plates can only be superimposed along the height of the storage rack with poor stability. By arranging the clip pieces at the installation positions of different heights of the bamboo-joint rod, the present disclosure enables the spacing between tier-panels to change for the main tier-panel and the accessory tier-panel, and enables the storage rack not only to be connected in parallel, but also to change the spacing and number of tier-panels in the vertical direction, so as to make use more flexible.

The above content is only preferred examples of the present disclosure, not pose any limitations on the present disclosure, so a person skilled in the art can make various changes and variations on the present disclosure. Any modifications, equivalent replacements, improvements and the likes made within the essence and principle of the present disclosure should fall within the protection scope of protection of the present utility mode.

What is claimed is:

1. A parallelly-connectable storage, characterized in that it comprises:
a plurality of bamboo-joint rods, which are vertically arranged, and each of which is provided with a plurality of installation positions in its length direction;
a clip piece arranged at the installation position of said bamboo-joint rod;
a main tier-panel, of which four corners are respectively provided with a tapered casing trapping said clip piece, and which is respectively provided with two hook holes on two end faces spliced with each other; and
an accessory tier-panel, of which two corners of one end is provided with tapered casings used to trap said clip piece, wherein two hook holes are opened on the end face of one side provided with said tapered casings, and of which the other end is provided with two hooks used to connect with the hook holes disposed on said main tier-panel or other accessory tier-panels at the same height.

2. The parallelly-connectable storage according to claim 1, characterized in that said main tier-panel and said accessory tier-panel both include a edge frame and a storage plate, and said storage plate is fixed on the inner edge of said edge frame.

3. The parallelly-connectable storage according to claim 2, characterized in that said hook hole is formed by way of pressing said edge frame outwards as a through groove protruding outwards at middle and opening upwards and downwards, the hook on said accessory tier-panel faces downwards and is hung in said hook hole during assembling.

4. The parallelly-connectable storage according to claim 2, characterized in that said storage plate may be a metal sieve pore plate or a wooden board.

5. The parallelly-connectable storage according to claim 1, characterized in that said clip piece includes a first clipping piece and a second clipping piece, and said first clipping piece and said second clipping piece are each a semicircular rod wall; a concave portion and a convex portion are respectively disposed on the two mounting sides of said first clipping piece, correspondingly a concave portion and a convex portion matched with said first clipping piece are respectively disposed on the two mounting sides of said second clipping piece, thus said first clipping piece and said second clipping are spliced with each other to be like a tube.

6. The parallelly-connectable storage according to claim 5, characterized in that an annular groove is set at the installation position of said bamboo-joint rod, and a protruding restricting ring is set on the inner side of said clip piece, thus said restricting ring is trapped in said annular groove at the installation position of said bamboo-joint rod.
